(19) United States
(12) Patent Application Publication
(10) Pub. No.: US 2004/0244220 A1
(43) Pub. Date: Dec. 9, 2004

(54) Multi-zone, multi-conveyor dryer and conversion methods and kit

(76) Inventors: Philip K Zietlow, Wayzata, MN (US); Mark R. Boyd, Buffalo, MN (US)

Correspondence Address: John O'Toole, General Mills, Inc., 1 General Mills Blvd., P.O. Box 1113, Minneapolis, MN, 55440, US

(21) Appl. No.: 10/374,758

(22) Filed: Feb. 25, 2003

(51) Int. Cl. F26B 19/00

(52) U.S. Cl. 34/236

(57) ABSTRACT

A method of converting a single-zone, multi-conveyor dryer into a multi-zone multi-conveyor dryer (10) utilizes a conversion kit including a division plate (40) and first and second panels including exit openings (42, 44, 46) and entrance openings (52, 54). The division plate (40) divides the heat chamber (14) into an upper zone (14a) and a lower zone (14b). The first panel is located between a first air plenum (20a) and the heat chamber (14), with the first air plenum (20a) including first and second heat sources (22, 22a) for heating the upper zone (14a) to a temperature greater than the lower zone (14b). The second heat source (22a) is pivotal relative to the first heat source (22) between an operative position and a cleaning position. The second panel is located between a second air plenum (20b) and the heat chamber (14). An extension (56) extends through a wall (21) between the air plenums (20a, 20b), with the entrance opening (54) located in the second panel and within the extension (56) in the first panel. The conversion kit further includes replacement motors for the air circulating devices (24) of higher power for increasing the air circulation rates between the air plenums (20a, 20b) and the heat chamber (14).

### BACKGROUND

The present invention relates generally to conveyor material dryers and particularly to multi-conveyor material dryers and relates specifically to multi-zone, multi-conveyor dryers and in the most preferred form to conversion kits for converting single-zone, multi-conveyor dryers into multi-zone, multi-conveyor dryers.

In conveyor type dryers, the material to be dried is transported through a dryer chamber, and the material is dried by causing the drying air to be passed vertically through the material on the conveyor as the material moves through the drying chamber. To increase residence time while shortening the chamber length, multiple conveyors are provided in the drying chamber where the material to be dried is transferred from one conveyor to another conveyor moving in the opposite direction. It can be appreciated that an even number of conveyors can be included such as in the event that material is desired to be introduced and exit in the same end of the drying chamber or an odd number of conveyors can be included such as in the event that material is desired to be introduced and exit in opposite ends of the drying chamber.

It should be appreciated that a dryer is one component in a production line for any given product such as a breakfast cereal or a snack product. Additionally, the through put of the production line is limited by the maximum capacity of each of the individual components which make up the production line. Thus, there is always an attempt to increase the capacity of the component in the production line which has the smallest capacity in potential through put. Significant strides have been made in increased efficiency and through put in components upstream and downstream of the dryer in the production line. Thus, there also exists a need for dryers having increased efficiency and through put so that the dryer is not the component which limits the through put of the production line.

Further, the ability to replace an existing dryer with a dryer of increased capacity may be restricted for a variety of reasons. A typical way to increase drying capacity is to add additional dryers and/or increase the size of the dryer chamber and the total conveyor length. The problem is that this may not be possible because of the inability to fit additional and/or larger dryers in the production line due to facility size or constraints, production line restraints, or the like. Further, even if possible, it would typically be necessary to shut down the production line during the time that the dryers are added and/or substituted which can be for an extended period of time in the order of several weeks, resulting in loss of product production and profits. Additionally, dryers involve considerable investment of capital, so that it is more desirable to increase the efficiency of existing dryers rather than replace the existing dryers with new dryers.

It is well known that higher temperatures result in faster drying. It is also recognized that although higher temperatures can be utilized during the start of the drying process when the material has higher moisture content, higher temperatures can result in damage to the material at the end of the drying process when the material has lower moisture content. In particular, as an example for some sugar coated breakfast cereals if drying temperatures exceeded 240° at the end of the drying process, material being dried may have a frosting or white sugar glaze which may be undesirable. Thus, single-zone dryers operate at temperatures below 240° F. However, two-zone dryers have been created allowing initial drying at higher temperatures and final drying at lower temperatures. For a variety of reasons including lower costs and sufficient capacity when installed, many production lines utilize single-zone dryers. However, because of increased efficiency and through put of the remaining components in the production line, such single-zone dryers become the through put limiting component.

For the reasons previously set forth, a need exists to increase the capacity of existing dryers and in preferred aspects to convert existing single-zone dryers to two-zone dryers.

### SUMMARY

The present invention solves this need and other problems in the field of multi-zone, multi-conveyor dryers by providing, in preferred aspects, a division plate dividing a heat chamber into an upper zone and a lower zone, with material passing through the upper zone on an upper conveyor and passing through the lower zone on a lower conveyor, an entrance opening and an exit opening between a first air plenum and the upper zone, and an entrance opening and an exit opening between a second air plenum and the lower zone, with heated air flowing from each of the first and second air plenums into the heat chamber through the entrance openings and from the heat chamber back into each of the first and second air plenums through the exit openings, with the temperature of the air flowing into the upper zone being elevated from that of the lower zone. In most preferred aspects, the multi-zone dryer is converted from a single-zone dryer utilizing a conversion kit.

It is thus an object of the present invention to provide a novel multi-zone, multi-conveyor dryer.

It is further an object of the present invention to provide such a novel multi-zone, multi-conveyor dryer converted from a single-zone, multi-conveyor dryer.

These and further objects and advantages of the present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a diagrammatic side view of a conventional material dryer, with portions broken away to show internal details.

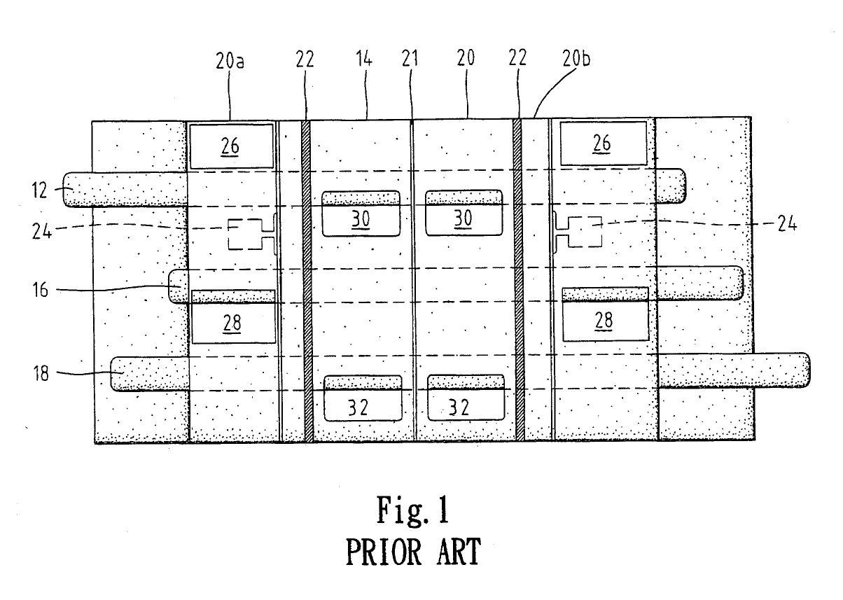

FIG. 2 shows a diagrammatic side view of a multi-zone, multi-conveyor dryer according to the preferred teachings of the present invention, with portions broken away to show internal details.

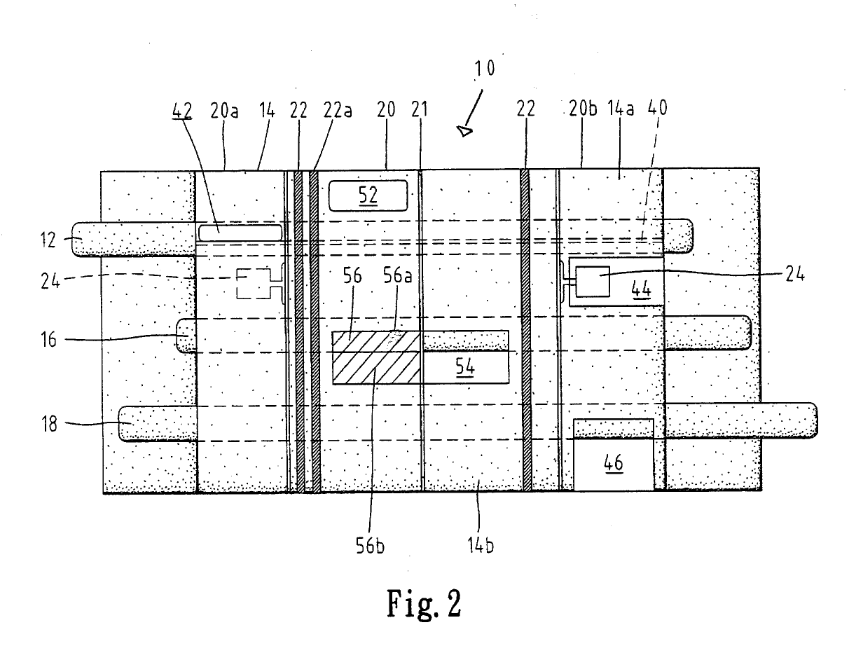

FIG. 3 shows a diagrammatic top view of the multi-zone, multi-conveyor dryer of FIG. 2, with portions broken away to show internal details.

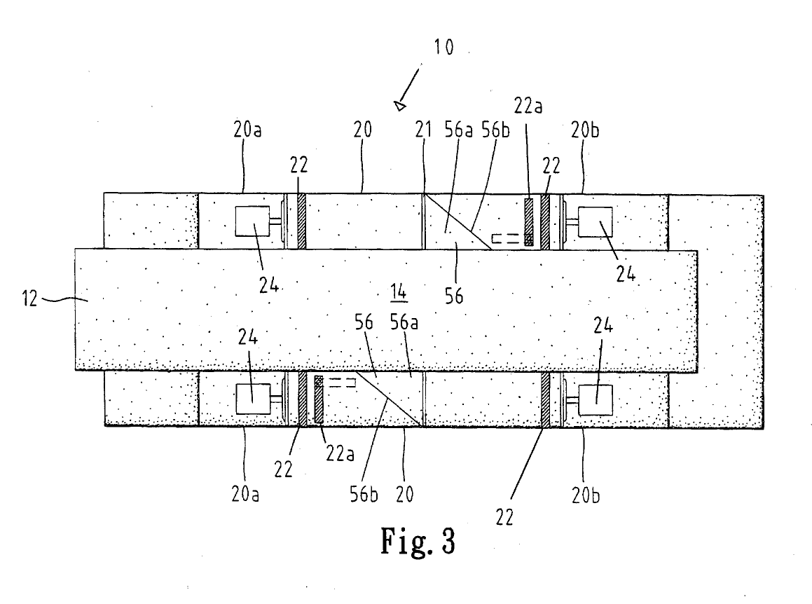

FIG. 4 shows a diagrammatic side view of a second heat source utilized in the multi-zone, multi-conveyor dryer of FIG. 2.

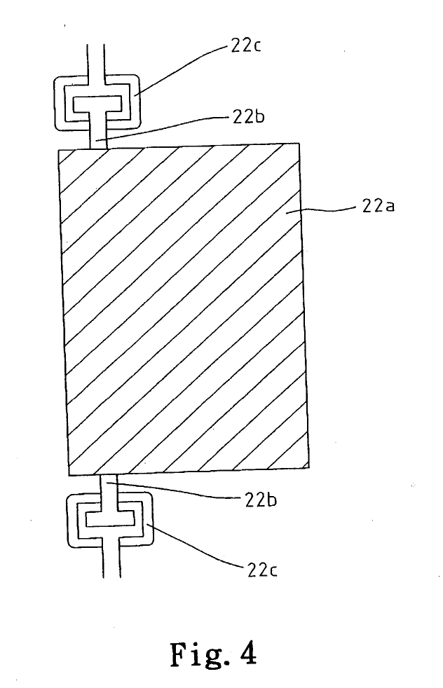

All figures are drawn for ease of explanation of the basic teachings of the present invention only; the extensions of the figures with respect to number, position, relationship, and dimensions of the parts to form the preferred embodiment will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in the various figures of the drawings, the same numerals designate the same or similar parts. Furthermore, when the terms “side”, “end”, “bottom”, “first”, “second”, “inside”, “upper”, “lower”, “intermediate” and similar terms are used herein, it should be understood that these terms have reference only to the structure shown in the drawings as it would appear to a person viewing the drawings and are utilized only to facilitate describing the illustrative embodiment.

### DESCRIPTION

A method utilizing a preferred kit for converting a single-zone, multi-conveyor dryer to a multi-zone, multi-conveyor dryer according to the preferred teachings of the present invention is shown in the drawings. Specifically, dryer 10 as shown includes a first, upper conveyor 12 for receiving material to be dried and for transporting it through a heat chamber 14 in a first conveying direction. Material falls from first conveyor 12 onto a second, intermediate conveyor 16 which transports it through heat chamber 14 in a second conveying direction parallel to, below, and in the opposite direction to first conveyor 12. Material falls from second conveyor 16 onto third, lower conveyor 18 which transports it through heat chamber 14 in a third conveying direction parallel to, below, and in the opposite direction to second conveyor 16 and parallel to, below, and in the same direction as first conveyor 12. Material falls from third conveyor 18 for exiting from dryer 10. Material spends approximately the same amount of time in heat chamber 14 on conveyors 12, 16 and 18. It should be appreciated that dryer 10 includes suitable provisions such as slitted plastic sheeting to minimize air flow around the ends of conveyors 12, 16 and 18. Conveyors 12, 16 and 18 can be of a variety of forms and do not form a part of the present invention. Likewise, although three conveyors 12, 16 and 18 have been shown, dryers 10 according to the teachings of the present invention can include two or four or more conveyors 12, 16, and 18.

Dryer 10 further includes an air plenum 20 for directing air flow into and out of heat chamber 14 shown in the most preferred form as a parellepiped on both sides of heat chamber 14 and conveyors 12, 16 and 18. Additionally, air plenum 20 is divided in the most preferred form by a wall 21 into two halves which for purposes of explanation are labeled a front half 20a and a rear half 20b which each form an individual air plenum. Each half 20a and 20b includes a source 22 of heat which typically is in the form of steam coils located generally perpendicular to the conveying directions and midway in each half 20a and 20b. A device of circulating air 24 which typically is in the form of a fan is located in or associated with each half 20a and 20b. Dryer 10 further includes suitable provisions for removing moisture laden air and replacing the removed moisture laden air with heated, dried air, which provisions can be of a variety of forms and do not form a part of the present invention. In this regard, approximately 10% of the circulating air is typically drawn off to remove moisture, while 90% of the air is simply recirculated.

In conventional dryers, air is removed from heat chamber 14 through an exit opening 26 above the upper row of first conveyor 12 and through an exit opening 28 below the upper run of second conveyor 16 and above the upper run of third conveyor 18. In this regard, air can be removed through exit opening 28 from below the lower run of second conveyor 16 or from intermediate the upper and lower runs of conveyor 16. Air passes from exit openings 26 and 28 through heat source 22 (under the influence of air circulating device 24) where it is heated and passes into heat chamber 14 through an entrance opening 30 located below the upper run of first conveyor 12 and above the upper run of second conveyor 16 and through an entrance opening 32 located below the upper run of third conveyor 18. In this regard, air can be introduced through opening 30 below the lower run of first conveyor 12 or including intermediate the upper and lower runs of conveyor 12 and through opening 32 below the lower run of third conveyor 18 or including intermediate the upper and lower runs of conveyor 18. In the most preferred form, openings 30 and 32 of halves 20a and 20b are located adjacent to each other and are located intermediate openings 26 and 28 of halves 20a and 20b. It should be appreciated that there is no significant difference in temperature between halves 20a and 20b or between portions of heat chamber 14. Likewise, air plenums 20 are located on both sides of heat chamber 14 of an identical construction. It should be appreciated that based upon the assumption that air will take the path of least resistance inside of chamber 14 between entrance openings 30 and 32 and exit openings 26 and 28, air will flow through the upper run and the material thereon of the associated conveyor 12, 16 and 18.

Dryer 10 according to the teachings of the present invention includes several improvements which result in a different mode of operation. In particular, a division plate 40 is installed in heat chamber 14 and divides heat chamber 14 into an upper zone 14a and a lower zone 14b. In the preferred form, material on conveyor 12 is located in upper zone 14a, and material on conveyors 16 and 18 is located in lower zone 14b. In the most preferred form, plate 40 is located intermediate the upper and lower runs of conveyor 12, but plate 40 could also be positioned below the lower run of conveyor 12 according to the teachings of the present invention. Plate 40 is impervious to air flow and thus generally prevents air passage between zones 14a and 14b therethrough such that air movement between the upper and lower zones 14a and 14b is minimized.

In dryer 10 according to the teachings of the present invention, air is removed from heat chamber 14 through an exit opening 42 above plate 40 and below the upper run of conveyor 12, through an exit opening 44 below plate 40 and above the upper run of conveyor 16, and through an exit opening 46 below the upper run of conveyor 18. In the preferred form, opening 42 is located in front half 20a on a first side of dryer 10 and in rear half 20b in the opposite side of dryer 10. Likewise, openings 44 and 46 are located in rear half 20b on the first side of dryer 10 and front half 20a in the opposite side of dryer 10. Air passes from exit opening 42 through heat source 22 (under the influence of air circulating device 24) where it is heated and passes into heat chamber 14 through an entrance opening 52 located above the upper run of conveyor 12. Air passes from exit openings 44 and 46 through heat source 22 (under the influence of air circulating device 24) where it is heated and passes into heat chamber 14 through an entrance opening 54 located below the upper run of conveyor 16 and about the upper run of conveyor 18. In most preferred form and to generally match exit openings 44 and 46 in size, an extension 56 is provided through wall 21. In particular and in the preferred form, extension 56 includes upper and lower plates 56a having a horizontal extent outward from heat chamber 14 generally equal to that of wall 21 and has a horizontal extent parallel to the conveying direction generally equal to but slightly less than the spacing of heat source 22 from wall 21. Extension 56 also includes a vertical plate 56b extending between the outer edges of plates 56a. Thus, in the first side of dryer 10 shown in the drawings, extension 56 and opening 54 extend from wall 21 into front half 20a and in the opposite side of dryer 10, extension 56 and opening 54 extends from wall 21 into rear half 20b.

It should be appreciated that openings 42 and 52 in the respective half 20a and 20b communicate only with zone 14a and generally not with zone 14b to substantially prevent air flow with zone 14b. Similarly, openings 44, 46 and 54 in the respective half 20a and 20b communicate only with zone 14b and generally not with zone 14a to substantially prevent air flow with zone 14a. According to the teachings of the present invention, halves 20a and 20b including openings 42 and 52 and thus zone 14a is heated to a greater temperature than halves 20a and 20b including openings 44, 46 and 54 and thus zone 14b. In the most preferred form, air flowing into zone 14a has a temperature in the order of 300° F. whereas air flowing into zone 14b has a temperature in the order of 210-240° F. It should also be appreciated that in the embodiment shown, only conveyor 12 is located in zone 14a whereas two conveyors 16 and 18 are present in zone 14b such that the residence time in zone 14b is roughly double that in zone 14a.

It should be appreciated that especially for halves 20a and 20b including openings 42 and 52 having a higher temperature than that of conventional dryer, heat source 22 of the conventional dryer may be insufficient to deliver sufficient heat to result in the desired temperature of zone 14a. Thus, according to the preferred form of the present invention, two heat sources 22 and 22a are provided horizontally spaced between openings 42 and 52.

It should be appreciated that material dust and other debris tends to be carried by air movement and often lodges or otherwise collects on heat source 22. Thus, to increase heat transfer efficiency and to reduce the risk of burning, it is necessary to clean heat source 22. To increase the areas of openings 42 and 52, it is desired to decrease the horizontal spacing therebetween, with heat source 22 being positioned in the horizontal spacing between openings 42 and 52. Thus, when multiple heat sources 22 and 22a are utilized, it is necessary to place them close together, which can make cleaning very difficult. In the most preferred form, the first heat source 22 is mounted in a stationary manner generally perpendicular to the conveying directions as in conventional dryers. However, the second heat source 22a is mounted in a pivotal manner about a vertical axis in the preferred form such that second heat source 22a is pivotal between an operative position generally perpendicular to the conveying directions and parallel to and slightly spaced from first heat source 22 and a cleaning position generally parallel to the conveying directions and at a nonparallel angle and preferably perpendicular to first heat source 22. In the most preferred form where heat source 22 is in the form of steam radiators, the inlet and outlet 22b to heat source 22a are linearly arranged, have a vertical orientation and are arranged in rotary unions or swivel joints 22c which allow passage of steam therethrough but allow relative pivotal movement about an axis defined by inlet and outlet 22b. Additionally, in the preferred form where steam is the source of heat, the steam control valves are opened approximately 90% of the time for heat sources 22 and 22a for intake zone 14a but are opened approximately 40% of the time for heat sources 22 for lower zone 14b.

As heat transfer is a function of air speed, air circulating devices 24 according to the preferred teachings of the present invention are operated at higher flow rates in the order of 8700 cubic feet per minute in dryer 10 of the most preferred form, with air circulating devices 24 of conventional dryers providing about 75% of that rate. In the most preferred form, the conventional air circulating device 24 is utilized but are rotated at speeds of roughly 1200 RPM as compared to about 8-900 RPM for conventional dryers. To provide the increased RPM, dryer 10 of the most preferred form utilizes replacement motors of greater power in air circulating devices 24 and specifically in the most preferred form having 20 horsepower in comparison to 15 horsepower for conventional dryers.

Now that the basic construction of dryer 10 according to the preferred teachings of the present invention has been set forth, some of the advantages of dryer 10 according to the present invention can be highlighted. Specifically, in the most preferred form, a conventional single-zone, multi-conveyor dryer is converted into dryer 10 according to the teachings of the present invention. In particular, plate 40 can be prefabricated for insertion into heat chamber 14 relative to conveyor 12 to divide chamber 14 into zones 14a and 14b. Similarly, panels which define the division between chamber 14 and plenum 20 and including openings 42, 44, 46, 52 and 54 can be prefabricated individually or together for replacement of corresponding locations in the conventional dryer. Likewise, extension 56 can be prefabricated and inserted into plenum 20 after a corresponding opening is cut in wall 21. Heat source 22a, if needed, is prefabricated for installation into the conventional dryer. Likewise, higher powered motors can be purchased and replaced for the motors of air circulating devices 24 of the conventional dryer.

According to the preferred teachings of the present invention, each of the improvements can be replaced while the conventional dryer is in position and can be rapidly performed such as over a weekend, preferably when the production line is down for other reasons. It should be appreciated that the major portion of the conventional dryer remains in place without replacement such that a conventional dryer can be converted to dryer 10 according to the teachings of the present invention with lesser investment of capital. The overall size of dryer 10 of the present invention is generally the same as the conventional dryer from which it was converted. Additionally, the conversion can be accomplished in considerable less time than if a tear-out and total replacement were performed. Thus, the down time for the production line as a result of the dryer conversion is minimized.

Additionally, because of the provision of two-zone heating, the capacity of dryer 10 according to the teachings of the present invention is considerably increased and in the preferred form is doubled. In particular, drying time utilizing dryer 10 of the preferred form is about half of the drying time for a conventional dryer, with a residence time of material in dryer 10 according to the most preferred form being 2 to 3 minutes versus 3 to 8 minutes for a conventional dryer of the same physical size. Residence time can be reduced by increasing the conveying speeds of conveyors 12, 16, and 18 such that material thereon spends less time in heat chamber 14. Typically, material entering dryer 10 will have a moisture content of 10-12%, and it is desired to have material leave dryer 10 having a 2% moisture content. Material leaving conveyor 12 of dryer 10 typically will have a moisture content of approximately 5% according to the preferred teachings of the present invention versus 8 to 9% for conventional, single-zone dryers. The quicker and larger reduction of moisture content is the result of the higher temperature of the intake zone 14a of multi-zone dryer 10 according to the present invention.

Now that the basic construction and advantages of dryer 10 according to the preferred teachings of the present invention has been explained, many extensions and variations will be obvious to one having ordinary skill in the art. For example, although dryer 10 according to the preferred teachings of the present invention has been set forth created from the conversion of a conventional single-zone dryer, which conversion took considerable invention, dryer 10 according to the teachings of the present invention could be created as an original article of manufacture.

Similarly, the conventional dryer can be of a variety of forms and types, with only one of such conventional form being described. However, a person skilled in the art may apply the teachings of the present invention to other forms and types of conventional dryers.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Method for converting a material dryer including a heat chamber through which at least an upper conveyor and a lower conveyor pass, with material from the upper conveyor being transferred to the lower conveyor, with the material dryer further including a first air plenum and a second air plenum, with heated air flowing from each of the first and second air plenums into the heat chamber and from the heat chamber back into each of the first and second air plenums, with the method comprising:
installing a division plate in the heat chamber to divide the heat chamber into an upper zone and a lower zone, with the upper zone including the material on the upper conveyor, with the lower zone including the material on the lower conveyor, with air movement between the upper and lower zones being minimized;
providing an entrance opening and an exit opening between the upper zone and the first air plenum while substantially preventing air flow between the lower zone and the first air plenum;
providing an entrance opening and an exit opening between the lower zone and the second air plenum while substantially preventing air flow between the upper zone and the second air plenum; and
heating air flowing between the upper zone and the first air plenum different than air flowing between the lower zone and the second air plenum.

2. The method of claim 1 with providing the entrance opening and the exit opening comprising providing the entrance opening on one side of material on the conveyor and providing the exit opening on an opposite side of material on the conveyor.

3. The method of claim 1 with the first and second air plenums being divided by a wall, with providing the entrance opening between the lower zone and the second air plenum comprising providing an extension through the wall from the second air plenum into the first air plenum and providing the entrance opening in the extension and in the second air plenum.

4. The method of claim 1 with air being heated in the first and second air plenums by a first heat source and with heating air between the upper zone and the first air plenum further comprising providing a second heat source in the first air plenum, with air flowing through the first and second heat sources in the first air plenum and from the first air plenum into the upper zone of the heat chamber.

5. The method of claim 4 with providing the second heat source comprising pivotally mounting the second heat source in the first air plenum between an operative position parallel to and slightly spaced from the first heat source and a cleaning position extending at a nonparallel angle to the first heat source.

6. The method of claim 5 with pivotally mounting the second heat source comprising providing the second heat source with an inlet and an outlet linearly arranged with the inlet, and providing swivel joints with the inlet and the outlet allowing relative pivotal movement about an axis defined by the inlet and the outlet.

7. The method of claim 1 with heated air flowing from each of the first and second air plenums under the influence of air circulating devices, with the method further comprising increasing air circulation rates of the air circulating devices, with increasing the air circulation rates comprising replacing motors of the air circulating devices with motors of greater power.

8. The method of claim 1 with heating air comprising heating air flowing between the upper zone and the first air plenum greater than air flowing between the lower zone and the second air plenum.

9. Conversion kit for a material dryer including a heat chamber through which at least an upper conveyor and a lower conveyor pass, with material from the upper conveyor being transferred to the lower conveyor, with the material dryer further including a first air plenum and a second air plenum, with heated air flowing from each of the first and second air plenums into the heat chamber and from the heat chamber back into each of the first and second air plenums, with the conversion kit comprising, in combination:
a division plate adapted to be received in the heat chamber for dividing the heat chamber into an upper zone and a lower zone, with the upper zone including the material on the upper conveyor, with the lower zone including the material on the lower conveyor, with air movement between the upper and lower zones being minimized;
a first panel adapted to divide the heat chamber from the first air plenum, with the first panel including an entrance opening and an exit opening between the upper zone and the first air plenum while substantially preventing air flow between the lower zone and the first air plenum; and
a second panel adapted to divide the heat chamber from the second air plenum, with the second panel including an entrance opening and an exit opening between the lower zone and the second air plenum while substantially preventing air flow between the upper zone and the second air plenum.

10. The conversion kit of claim 9 with the entrance opening and the exit opening adapted to be located on opposite sides of material on the conveyor.

11. The conversion kit of claim 9 with the first and second air plenums being divided by a wall, with the conversion kit further comprising, in combination: an extension adapted to be inserted through the wall and to extend over the first panel, with the entrance opening of the second panel extending into the first panel and within the extension.

12. The conversion kit of claim 9 with air being heated in the first and second air plenums by a first heat source, with the conversion kit further comprising, in combination: a second heat source in the first air plenum, with air flowing through the first and second heat sources in the first air plenum and from the first air plenum into the upper zone of the heat chamber.

13. The conversion kit of claim 12 with the second heat source being pivotally mounted in the first air plenum between an operative position parallel to and slightly spaced from the first heat source and a cleaning position extending at a nonparallel angle to the first heat source.

14. The conversion kit of claim 13 with the second heat source including an inlet and an outlet linearly arranged with the inlet; and with the conversion kit further comprising, in combination: swivel joints with the inlet and the outlet allowing relative pivotal movement about an axis defined by the inlet and the outlet.

15. Material dryer comprising, in combination: a heat chamber; at least an upper conveyor and a lower conveyor passing through the heat chamber, with material from the upper conveyor being transferred to the lower conveyor; a division plate dividing the heat chamber into an upper zone and a lower zone, with the upper zone including material on the upper conveyor, with the lower zone including material on the lower conveyor, with air movement between the upper and lower zones being minimized; a first air plenum; an entrance opening and an exit opening between the upper zone and the first air plenum while substantially preventing air flow between the lower zone and the first air plenum; a second air plenum; and an entrance opening and an exit opening between the lower zone and the second air plenum while substantially preventing air flow between the upper zone and the second air plenum, with heated air flowing from each of the first and second air plenums into the heat chamber through the entrance openings and from the heat chamber back into each of the first and second air plenums through the exit openings.

16. The material dryer of claim 15 with the entrance opening and the exit opening adapted to be located on opposite sides of material on the conveyor.

17. The material dryer of claim 15 with the first and second air plenums being divided by a wall, with the material dryer further comprising, in combination: an extension adapted to be inserted through the wall, with the entrance opening between the lower zone and the second air plenum extending within the extension.

18. The material dryer of claim 15 with air being heated in the first and second air plenums by a first heat source, the material dryer further comprising, in combination: a second heat source in the first air plenum, with air flowing through the first and second heat sources in the first air plenum and from the first air plenum into the upper zone of the heat chamber.

19. The material dryer of claim 18 with the second heat source being pivotally mounted in the first air plenum between an operative position parallel to and slightly spaced from the first heat source and a cleaning position extending at a nonparallel angle to the first heat source.

20. The material dryer of claim 19 with the second heat source including an inlet and an outlet linearly arranged with the inlet; and with the material dryer further comprising, in combination: swivel joints with the inlet and the outlet allowing relative pivotal movement about an axis defined by the inlet and the outlet.
